(19) United States
(12) Patent Application Publication
(10) Pub. No.: US 2024/0330143 A1
(43) Pub. Date: Oct. 3, 2024

(54) EFFICIENT TRAINING OF MACHINE LEARNING MODELS FOR LOG RECORD ANALYSIS

(71) Applicant: BMC Software, Inc., Houston, TX (US)

(72) Inventors: Vikas Prasad, Pune (IN); Rakesh Tiwari, Pune (IN); Sameer Mardhekar, Pune (IN); Ajoy Kumar, Santa Clara, CA (US)

(21) Appl. No.: 18/194,190

(22) Filed: Mar. 31, 2023

(51) Int. Cl. G06F 11/34

(52) U.S. Cl. CPC G06F 11/3476

(57) ABSTRACT

A plurality of log records characterizing operations occurring within a technology landscape may be received. The plurality of log records may be clustered into at least a first cluster of log records and a second cluster of log records, using at least one similarity algorithm. A first dissimilar subset of log records within the first cluster of log records, and a second dissimilar subset of log records within the second cluster of log record may be identified, using the at least one similarity algorithm. At least one machine learning model may be trained to process new log records characterizing the operations occurring within the technology landscape, using the first dissimilar subset and the second dissimilar subset.

### TECHNICAL FIELD

This description relates to training machine learning models for log record analysis.

### BACKGROUND

Many companies and other entities have extensive technology landscapes that include numerous information technology (IT) assets, including hardware and software. It is often required for such assets to perform at high levels of speed and reliability, while still operating in an efficient manner. For example, various types of computer systems are used by many entities to execute mission critical applications and high volumes of data processing, across many different workstations and peripherals. In other examples, customers may require reliable access to system resources.

Various types of system monitoring methods are used to detect, predict, prevent, mitigate, or cure system faults that might otherwise disrupt or prevent monitored IT assets, such as executing applications, from achieving system goals. For example, it is possible to monitor various types of log records characterizing aspects of system performance, such as application performance. The log records may be used to train one or more machine learning (ML) models, which may then be deployed to characterize future aspects of system performance.

Such log records may be automatically generated in conjunction with system activities. For example, an executing application may be configured to generate a log record each time a certain operation of the application is attempted or completes.

In more specific examples, log records are generated in many types of network environments, such as network administration of a private network of an enterprise, as well as in the use of applications provided over the public internet or other networks. This includes where there is use of sensors, such as internet of things devices (IoT) to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). Log records are also generated in the use of individual IT components, such as a laptops and desktop computers and servers, in mainframe computing environments, and in any computing environment of an enterprise or organization conducting network-based IT transactions, such as well as in executing applications, such as containerized applications executing in a Kubernetes environment or execution by a web server, such as an Apache web server.

Consequently, a volume of such log records may be very large, so that corresponding training of a ML model(s) may consume excessive quantities of memory and/or processing resources. Moreover, such training may be required to be repeated at defined intervals, or in response to defined events, which may further exacerbate difficulties related to excessive resource consumption. As a result, even if a ML model is accurately designed and parameterized, it may be difficult to train and deploy the ML model in an efficient and cost-effective manner when analyzing log records included in the training of the ML model.

### SUMMARY

According to one general aspect, a computer program product may be tangibly embodied on a non-transitory computer-readable storage medium and may include instructions. When executed by at least one computing device, the instructions may be configured to cause the at least one computing device to receive a plurality of log records characterizing operations occurring within a technology landscape and cluster the plurality of log records into at least a first cluster of log records and a second cluster of log records, using at least one similarity algorithm. When executed by the at least one computing device, the instructions may be configured to cause the at least one computing device to identify a first dissimilar subset of log records within the first cluster of log records, using the at least one similarity algorithm, identify a second dissimilar subset of log records within the second cluster of log records, using the at least one similarity algorithm, and train at least one machine learning model to process new log records characterizing the operations occurring within the technology landscape, using the first dissimilar subset and the second dissimilar subset.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a monitoring system with efficient training of machine learning models for log record analysis.

FIG. 2 is a flowchart illustrating example operations of the monitoring system of FIG. 1.

FIG. 3 illustrates example log records with similarity scores.

FIG. 4 illustrates example log record clusters.

FIG. 5 illustrates a selection of a first dissimilar log record from a log record cluster of FIG. 4.

FIG. 6 illustrates a selection process for finding additional dissimilar log records from a log record cluster of FIG. 4.

FIG. 7 illustrates a first result of the selection process of FIG. 6.

FIG. 8 illustrates a second result of the selection process of FIG. 6.

FIG. 9 is a block diagram illustrating example techniques for identifying an optimized number of dissimilar log records to select from a log record cluster of FIG. 4, using the techniques of FIGS. 5-8.

FIG. 10 is a flowchart illustrating operations corresponding to the techniques of FIGS. 3-9.

### DETAILED DESCRIPTION

Described systems and techniques provide efficient training of machine learning (ML) models used to monitor, analyze, and otherwise utilize log records that may be generated by an executing application or other system component. As referenced above, such log records may be voluminous, and conventional monitoring systems may be required to consume excessive quantities of processing and/or memory resources to train ML models in a desired fashion and/or within a desired timeframe. In contrast, described techniques train such ML models more quickly and/or using fewer memory/processing resources.

For example, described techniques enable intelligent sampling of log records to obtain subsets of log records that may then be used for improved ML model training. In more detail, described techniques process a large quantity of log records by first forming clusters of similar log records, and then sampling each resulting cluster to extract subsets of log records that are dissimilar from one another. The subsets of dissimilar log records from the various clusters are then used as sampled training data for training one or more ML models.

The resulting ML models may be as accurate, or almost as accurate, as ML models trained using an entirety of the original log records, even when the sampled training data is a minority percentage (such as 20% to 40%, e.g., 30%) of the original log records. Consequently, fewer memory/processing resources may be required to process the sampled training data, as compared to the entire set of log records, and the training may be completed more quickly, as well.

Additionally, described training techniques enable dynamic updating of the trained machine learning models over time, as well. For example, as new log records are received, the new log records may be incrementally added to the previously formed log record clusters. The resulting, updated log record clusters may then be analyzed again to find dissimilar log records therein, with the added log records included in the analysis. In this way, the subsets of log records used as the sampled training data may be incrementally updated on an as-needed basis, and without requiring re-processing of an entirety of available log records.

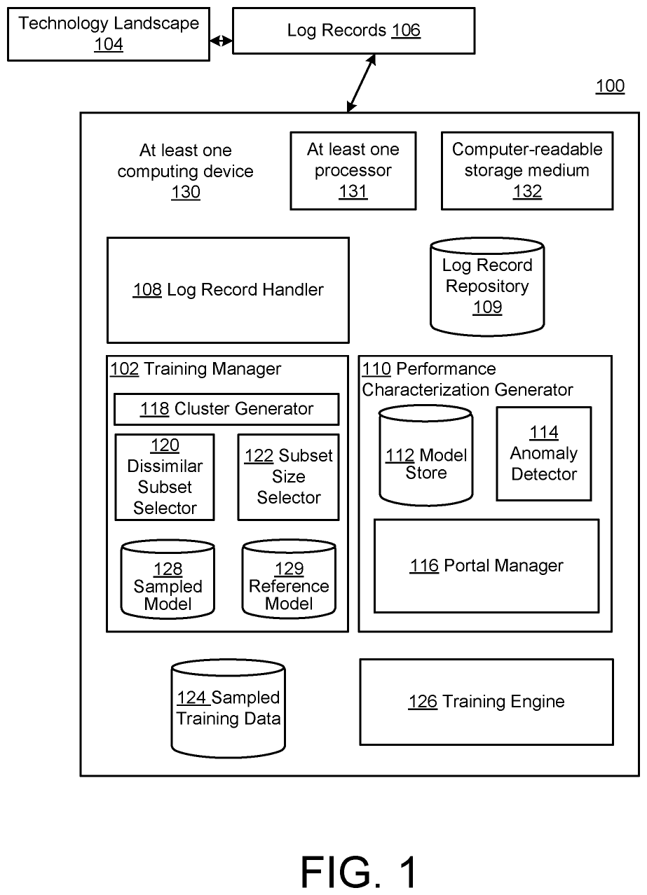

FIG. 1 is a block diagram of a monitoring system 100 with efficient training of machine learning models for log record analysis. In FIG. 1, a training manager 102 is configured to provide the type of ML training efficiencies just described, to enable accurate monitoring and analysis of log records, while conserving the use of associated hardware resources.

In more detail, in FIG. 1, a technology landscape 104 may represent or include any suitable source of log records 106 that may be processed by the training manager 102. A log record handler 108 receives the log records 106 over time and stores the log records 106 in one or more suitable storage locations, represented in FIG. 1 by a log record repository 109.

For example, as referenced above, the technology landscape 104 may include many types of network environments, such as network administration of a private network of an enterprise, or an application provided over the public internet or other network. Technology landscape 104 may also represent scenarios in which sensors, such as internet of things devices (IoT), are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the technology landscape 104 may include, or reference, an individual IT component, such as a laptop or desktop computer or a server. In some embodiments the technology landscape 104 may represent a mainframe computing environment, or any computing environment of an enterprise or organization conducting network-based IT transactions. In various examples that follow, the technology landscape 104 includes one or more executing applications, such as containerized applications executing in a Kubernetes environment, and/or includes a web server, such as an Apache web server.

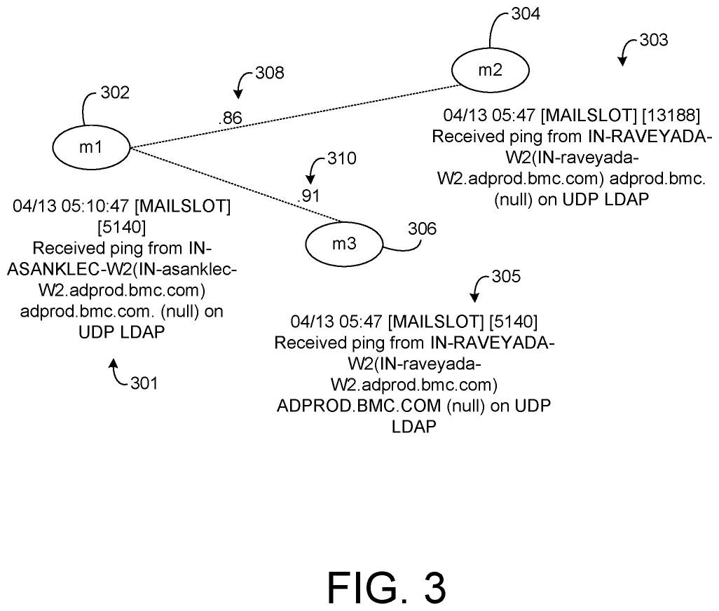

The log records 106 may thus represent any corresponding type(s) of file, message, or other data that may be captured and analyzed in conjunction with operations of a corresponding network resource within the technology landscape 104. For example, the log records 106 may include text files that are produced automatically in response to pre-defined events experienced by an application. For example, in a setting of online sales or other business transactions, the log records 106 may characterize a condition of many servers being used. In a healthcare setting, the log records 106 may characterize either a condition of patients being monitored or a condition of IoT sensors being used to perform such monitoring. Similarly, the log records 106 may characterize machines being monitored, or IoT sensors performing such monitoring, in manufacturing, industrial, oil and gas, energy, or financial settings. More specific examples of log records 106 are provided below, e.g., with respect to FIG. 3.

In FIG. 1, the log record handler 108 may ingest the log records 106 for storage in the log record repository 109. As referenced above, it is possible to use the log record repository 109 to enable a performance characterization generator 110 to use one or more trained ML models, represented in FIG. 1 as being stored using a model store 112, to analyze current or future log records and thereby identify, diagnose, interpret, predict, remediate, or otherwise characterize a performance of individual IT components (e.g., applications, computing devices, servers, or a mainframe) within the technology landscape 104.

In the example of FIG. 1, an anomaly detector 114 may detect anomalous behavior of an executing application, based on analysis of log records. For example, a trained ML model in the model store 112 may be applied to current log records received from an application to detect an abnormal latency of the application, or an abnormal usage of memory or processing resources. As referenced above, anomaly detection is merely one representative example of the types of performance characterizations that may be made using trained ML models within the model store 112.

Further in FIG. 1, a portal manager 116 may be configured to enable user access to the performance characterization generator 110. For example, the portal manager 116 may enable configuration of the anomaly detector 114, or selection of a desired ML model from the model store 112 from among a plurality of available ML models. The portal manager 116 may also be used to generate a graphical user interface (GUI) for displaying results of the anomaly detector 114 and/or for performing the types of configuration activities just referenced.

As referenced above, a quantity of log records 106 generated by the technology landscape 104 may be voluminous. For example, an executing application may be configured to generate a log record on a pre-determined time schedule. Such applications may be executing continuously or near-continuously, and may be executing across multiple tenants, so that hundreds of millions of log records may accumulate every day. Using conventional techniques, even if sufficient resources were devoted to train a corresponding ML model in ten minutes utilizing 100,000 log records, such resources would still require multiple days of total training time for such a volume of log records.

In many cases, the log records 106 may be highly repetitive. For example, log records produced for an application may contain the same or similar terminology. In a more specific example, some log records may relate to user log-in activities collected across many users attempting to access network resources. Such log records are likely to be similar and may differ primarily in terms of content that is likely to be non-substantive, such as dates/times of attempted access or identities of individual users.

As referenced above, and described in detail, below, the training manager 102 may be configured to leverage the similarity of the log records to obtain reductions in data volume without sacrificing accurate, reliable operation of the performance characterization generator 110. Specifically, the training manager 102 includes a cluster generator 118 that is configured to process log records from the log record repository 109 using one or more similarity algorithms, to thereby generate multiple clusters of similar log records.

For example, as described in detail, below, the cluster generator 118 may form multiple clusters of log records, in each of which all included log records are above a similarity threshold that is defined with respect to the similarity algorithm(s) being used. For example, the cluster generator 118 may select (e.g., randomly, or chronologically) a log record to serve as a cluster seed for a first cluster, and then compare a compared log record to the cluster seed log record. If the compared log record exceeds the defined similarity threshold, the compared log record may be added to the cluster of the cluster seed, and a subsequent compared log record may be analyzed. If the compared log record does not exceed the defined similarity threshold, the compared log record may be used as a new cluster seed of a subsequent (e.g., second) cluster. In this way, as described in more detail, below, the cluster generator 118 may iteratively process all relevant log records into a set of similar clusters.

A dissimilar subset selector 120 may be configured to analyze each cluster generated by the cluster generator 118 and extract a defined subset of log records that satisfy a dissimilarity criterion, or dissimilarity criteria. A size of each such dissimilarity subset may be set by a subset size selector 122.

For example, in an extremely simplified example provided for the sake of illustration, it may occur that a cluster defined by the cluster generator 118 includes 10 log records. A size set by the subset size selector 122 may be defined in terms of a percentage, e.g., 30%. Then, the dissimilar subset selector 120 may select three (i.e., 30% of 10) log records from the corresponding cluster as a dissimilarity subset, where the three selected log records satisfy the dissimilarity criteria of the dissimilar subset selector 120.

Detailed example operations of the dissimilar subset selector 120 and the subset size selector 122 are provided below. In some simplified examples for the sake of illustration, the dissimilar subset selector 120 may use the same or different similarity algorithm(s) as the cluster generator 118, and may initially select (e.g., randomly, or chronologically) a first log record of a first cluster as a subset seed. The dissimilar subset selector 120 may then analyze a compared log record of the cluster being analyzed with respect to the subset seed. If the compared log record does not satisfy the dissimilarity criteria, the compared log record may be discarded. If the compared log record does match the dissimilarity criteria, then it may be added to the dissimilar subset with the subset seed. In subsequent iterations, the next compared log record selected from within the cluster may be compared to the dissimilar subset (e.g., may be compared to some combination of the subset seed and the previously selected dissimilar log record(s)).

This process may be repeated until a size designated by the subset size selector is reached. In some implementations, it is not necessary for the dissimilar subset selector 120 to process all log records of a cluster(s). Rather, it is only necessary for the dissimilar subset selector 120 to process log records of a given cluster until a designated size of a dissimilar subset is reached. Consequently, processing performed by the dissimilar subset selector 120 may be completed quickly and efficiently.

Using the types of techniques described above, the training manager 102 may assemble sampled training data 124, which may then be processed by a training engine 126 to generate a sampled model 128, which may then be assigned to the model store 112. As may be understood from the preceding description, the sampled training data 124 may have a size that is significantly less than a size of the log record repository 109. For example, the sampled training data 124 may be reduced with respect to the log record repository 109 by a quantity that corresponds to a size determined by the subset size selector 122. For example, in the simplified example referenced above, in which a subset size is set to be 30% of a corresponding cluster of the cluster generator 118, the sampled training data 124 may be 30% of the log record repository 109 (assuming for the sake of the example that the log record repository 109 includes all log records currently being processed by the training manager 102).

It would be possible to simply perform random sampling of the log record repository 109 to obtain such a reduced set of training data. Such random sampling, however, will typically cause significant reductions in accuracy and reliability of resulting ML models. For example, since the log record repository 109 will typically contain many very similar log records, random sampling may result in a sampled set that also includes very similar log records, and that inadvertently omits dissimilar log records, where such dissimilar log records may be the most indicative of potential system anomalies or other system conditions desired to be detected or analyzed. Using the training engine 126 to train a ML model using such a randomly sampled set of log records may thus result in a ML model that does not accurately detect such anomalies or other conditions.

It is also possible to use all of the log records of the log record repository 109 when performing ML model training. For example, the training engine 126 may use an entirety of the log record repository 109 to generate a ML model, shown in FIG. 1 as a reference model 129. As described above, the reference model 129 may be accurate, but may require excessive resource consumption by the training engine 126 to be created and updated/replaced.

In example implementations, however, the reference model 129 may be generated infrequently to serve as a point of reference for the subset size selector 122 in defining an optimized subset size to be used by the dissimilar subset selector 120. That is, as referenced above, subset size may be set as a defined percentage of a corresponding cluster from which the dissimilar subset is determined. When the percentage is set to be very low (e.g., 5% or 10%), an accuracy of a resulting instance of the sampled model 128 may be compromised, relative to an accuracy of the reference model 129. On the other hand, when the percentage is set to be relatively high (e.g., 70% or 80%), resource consumption of the training engine 126 required to produce a resulting instance of the sampled model 128 may be excessive (e.g., may approach a level of resource consumption required to produce the reference model 129).

By testing a sampled accuracy of instances of the sampled model 128 with respect to a reference accuracy of the reference model 129, the subset size selector 122 may thus select an optimized subset size (such as 20% to 40%, e.g., 30%) to be used by the dissimilar subset selector 120. For example, the subset size selector 122 may select an optimized size which balances a desired level of accuracy of the resulting instance of the sampled model 128, relative to a quantity of resource consumption required to obtain that level of accuracy.

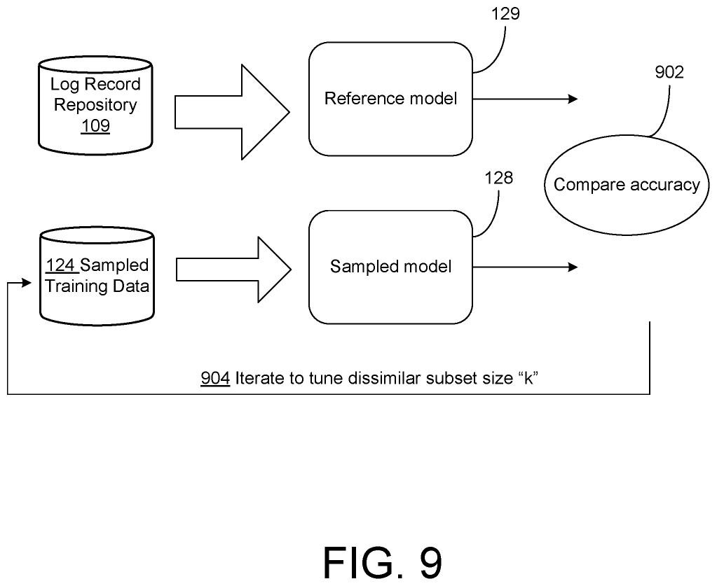

As described in more detail, below, with respect to FIG. 9, a level of optimization obtained is thus a matter of design choice. For example, some designers may trade increased levels of accuracy for improved levels of resource consumption, or vice versa.

In FIG. 1, the training manager 102 is illustrated as being implemented using at least one computing device 130, including at least one processor 131, and a non-transitory computer-readable storage medium 132. That is, the non-transitory computer-readable storage medium 132 may store instructions that, when executed by the at least one processor 131, cause the at least one computing device 130 to provide the functionalities of the training manager 102 and related functionalities.

For example, the at least one computing device 130 may represent one or more servers. For example, the at least one computing device 130 may be implemented as two or more servers in communications with one another over a network. Accordingly, the log record handler 108, the training manager 102, the performance characterization generator 110, and the training engine 126 may be implemented using separate devices in communication with one another. In other implementations, however, although the training manager 102 is illustrated separately from the performance characterization generator 110, it will be appreciated that some or all of the respective functionalities of either the training manager 102 or the performance characterization generator 110 may be implemented partially or completely in the other, or in both.

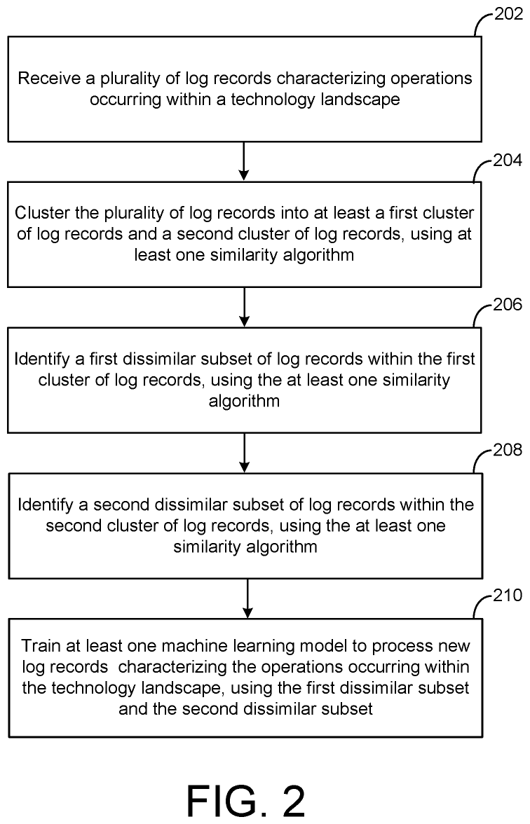

FIG. 2 is a flowchart illustrating example operations of the monitoring system 100 of FIG. 1. In the example of FIG. 2, operations 202 to 210 are illustrated as separate, sequential operations. In various implementations, the operations 202 to 210 may include sub-operations, may be performed in a different order, may include alternative or additional operations, or may omit one or more operations. Further, in all such implementations, included operations may be performed in an iterative, looped, nested, or branched fashion.

In FIG. 2, a plurality of log records characterizing operations occurring within a technology landscape 104 may be received (202). For example, as already described, the log record handler 108 may receive log records 106 from one or more components operating within the technology landscape 104, for storage, using the log record repository 109.

The plurality of log records may be clustered into at least a first cluster of log records and a second cluster of log records, using at least one similarity algorithm (204). For example, the cluster generator 118 may use a similarity algorithm to group log records in the log record repository 109 into a plurality of clusters. For example, each cluster may be defined with respect to a log record designated as a cluster seed. Each cluster seed may be designated based on its dissimilarity with respect to all other cluster seeds. Log record pairs may be defined, with each log record pair including one of the cluster seeds, and each log record pair may be assigned a similarity score using the similarity algorithm. Log records of each log record pair with similarity scores above a similarity threshold with respect to a corresponding cluster seed may thus be included within the corresponding cluster.

A first dissimilar subset of log records may be identified within the first cluster of log records, using the at least one similarity algorithm (206). For example, the dissimilar subset selector 120 may analyze the first cluster and identify a first dissimilar subset satisfying the dissimilarity criteria. As described above, a size of the first dissimilar subset may be determined by the subset size selector 122, e.g., using the reference model 129.

A second dissimilar subset of log records may be identified within the second cluster of log records, using the at least one similarity algorithm (208). For example, the dissimilar subset selector 120 may analyze the second cluster and identify a second dissimilar subset satisfying the dissimilarity criteria. As described above, a size of the second dissimilar subset may also be determined by the subset size selector 122, e.g., using the reference model 129.

At least one machine learning model may be trained to process new log records characterizing the operations occurring within the technology landscape, using the first dissimilar subset and the second dissimilar subset (210). For example, the first dissimilar subset and the second dissimilar subset may be stored with other dissimilar subsets of other clusters generated by the cluster generator 118 as the sampled training data 124, which may then be used by the training engine 126 to construct the sampled model 128. The sampled model 128 may be deployed as a ML model within the model store 112 of the performance characterization generator 110.

FIG. 3 illustrates example log records with similarity scores. In FIG. 3, a first log record 301 is represented by a first node 302, a second log record 303 is represented by a second node 304, and a third log record 305 is represented by a third node 306. That is, the nodes 302, 304, 306 should be understood to represent the three log records 301, 303, 305 for purposes of illustrating example operations of the training manager 102 of FIG. 1.

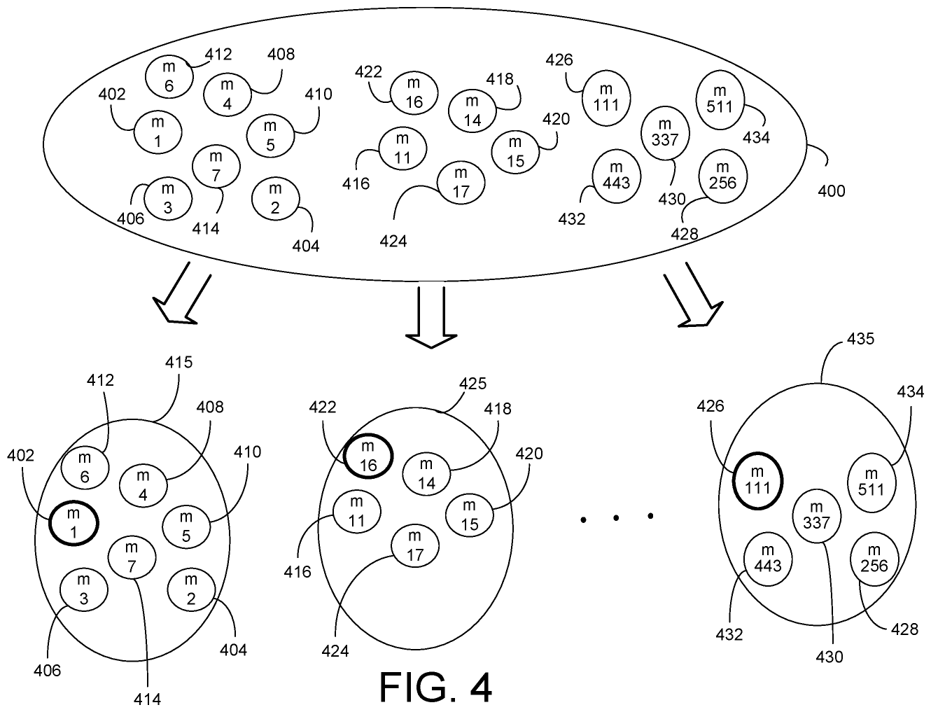

In particular, FIG. 3 illustrates that the first node 302 is assigned a similarity score 308 of 86 with respect to the second node 304, and is assigned a similarity score 310 of 0.91 with respect to the third node 306. FIG. 3, as well as FIGS. 4-8, generally illustrate such similarity scores using corresponding relative distances between pairs of nodes. For example, in FIG. 3, the pairwise comparison of the first node 302 with respect to the second node 304 is illustrated as being relatively farther apart than the pairwise comparison of the first node 302 with respect to the second node 304. Put another way, the third node 306 is illustrated (as may be seen, e.g., from the connecting dashed line(s)) as being relatively closer to the first node 302 than the second node 304, because the third node 306 (that is, the third log record 305) has a higher similarity to the first node 302 (that is, to the first log record 301) than does the second node 304 (that is, the second log record 303).

It will be appreciated that the examples of FIGS. 3-8 are included for the purposes of illustration and explanation. The various nodes and any connected edges are not required to be representative of any graphical output of operations of the training manager 102, although such graphical output may be generated.

In various example embodiments, the similarity score 308 and the similarity score 310, and any other similarity scores referenced herein, may be calculated using any one or more suitable similarity algorithms. For example, such similarity algorithms may include the string similarity algorithm, the cosine similarity algorithm, or the Log 2vec embedding similarity algorithm. Similarity algorithms may also combine text, numeric, and categorical fields contained in log records with assigned weights to determine similarity scores. In the examples provided, similarity scores are assigned a value between 0 and 1, or between 0% and 100%, but other scales or ranges may be used, as well.

FIG. 3 illustrates that the log records 301, 303, 305 may each include a timestamp and text describing a relevant process activity and associated network components/resources. In general, log records, such as the log records 301, 303, 305, may contain a designated structure, such as log level, module name, line number, and a text string describing a corresponding process condition, where such structural elements may be separated by designated characters and/or spaces.

For any long running applications, and for many other components of the technology landscape 104, such log records tend to be highly repetitive in nature, although with some differences in structural elements (such as a module name or a line number(s) of structural attributes). The example of FIG. 3 illustrates the log records 301, 303, 305 as being taken from domain controller logs and specifying a timestamp (April 13 05:10:47, a port number (5140 or 13188), a ping operation of named servers (ASANKLEC or RAVEYADA) and corresponding access protocol and other network information (Lightweight Directory Access Protocol (LDAP) on user datagram protocol (UDP)).

In FIG. 4, log records 400 correspond to example log records stored in the log record repository 109, e.g., the log records 302, 304, 306 of FIG. 3. As described with respect to FIG. 1, the cluster generator 118 may cluster the log records 400, based on pairwise similarity scores, corresponding to the similarity scores 308 and 310 of FIG. 3. For example, in FIG. 4, log records 402, 404, 406, 408, 410, 412, and 414 from the log records 400 are clustered into a first cluster 415. Log records 416, 418, 420, 422, and 424 from the log records 400 are clustered into a second cluster 425. Log records 426, 428, 430, 432, and 434 from the log records 400 are clustered into an N^{th} cluster 435.

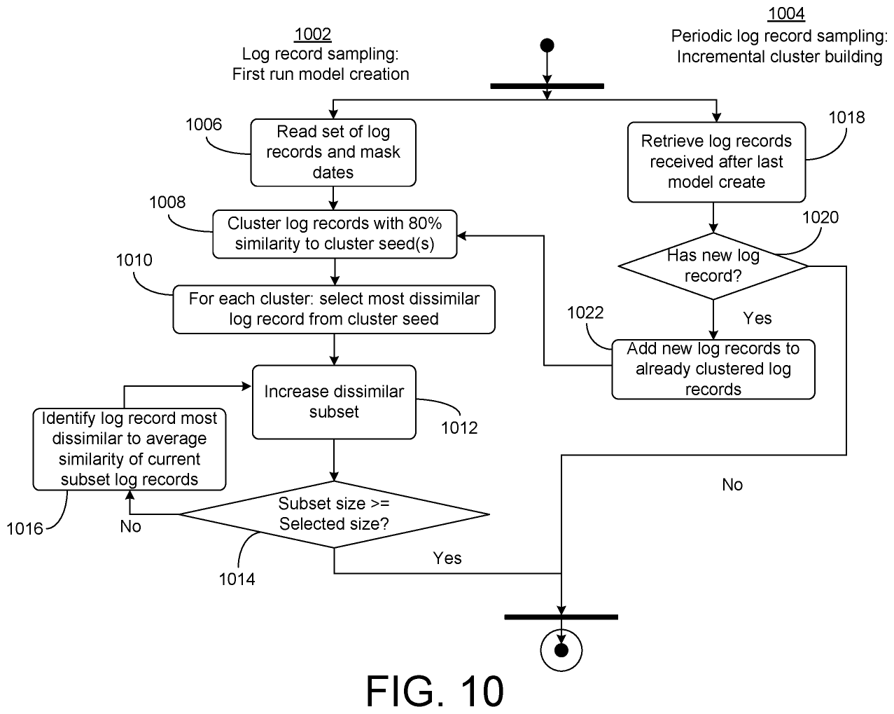

Thus, FIG. 4 illustrates that for any set of log records in the log record repository 109, N clusters of log records may be formed based on pairwise similarity of messages within each cluster. As referenced with respect to FIG. 1, and described in more detail, below, with respect to FIG. 10, the clusters 415, 425, 435 may be formed iteratively by selecting a log record as a cluster seed and performing pairwise similarity comparisons between the cluster seed and remaining log records to determine whether each compared log record should be assigned to the cluster of the cluster seed, or another cluster.

For example, when forming the clusters 415, 425, 435 from the log records 400, the log record 402 may be the cluster seed for the first cluster 415. The log record 402 may be selected to be the cluster seed based on any suitable criterion. For example, the log record 402 may be selected randomly, or may be selected as having the earliest timestamp.

Then, a subsequent log record may be compared to the log record 402. For example, the cluster generator 118 may calculate a similarity score, corresponding to the similarity score 308 or 310 of FIG. 3, between the cluster seed log record 402 and a compared log record, e.g., the log record 404. If the resulting similarity score is above a defined similarity threshold (e.g., 80%, or 0.8), then the compared log record 404 may be assigned to the first cluster 415, as shown.

A subsequent log record may be compared to the log record 402. For example, the cluster generator 118 may calculate a similarity score between the log record 402 and the log record 422. Assuming the log record 422 falls below the similarity threshold, the log record 422 will not be assigned to the first cluster 415, but will be designated as the cluster seed for the second cluster 425 to be formed.

Subsequent log records may then be compared to each of the first cluster seed log record 402 and the second cluster log seed record 422. Log records 404, 406, 408, 410, 412, 414 that exceed the similarity threshold with respect to the first cluster seed log record 402 may be assigned to the first cluster 415, while log records 416, 418, 420, 424 that exceed the similarity threshold with respect to the second cluster seed log record 422 may be assigned to the second cluster 425.

A compared log record that does not exceed the similarity threshold for either of the cluster seed log records 402, 422 may be designated as a cluster seed for a subsequent cluster being formed, e.g., a 3^{rd} cluster, or the N^{th} cluster 435. For example, the log record 426 may be designated as the cluster seed log record for the cluster 435.

As described above, e.g., with respect to the log records 301, 303, 305 of FIG. 3, log records may be expected to have high levels of similarity to at least a non-trivial number of other log records. Consequently, even if a number of log records increase exponentially, resulting sampled training data would not increase in the same proportions. Additionally, the number of clusters may be adjusted, e.g., by using a different similarity algorithm and/or by raising/lowering a required similarity threshold used during clustering operations.

Once the clusters 415, 425, . . . , 435 have been formed by the cluster generator 118, the dissimilar subset selector 120 may proceed to select, from each cluster, a dissimilar subset of log records. As described herein, a size of each such dissimilar subset may be determined by the subset size selector 122, with specific example techniques for subset size selection being provided with respect to FIG. 9.

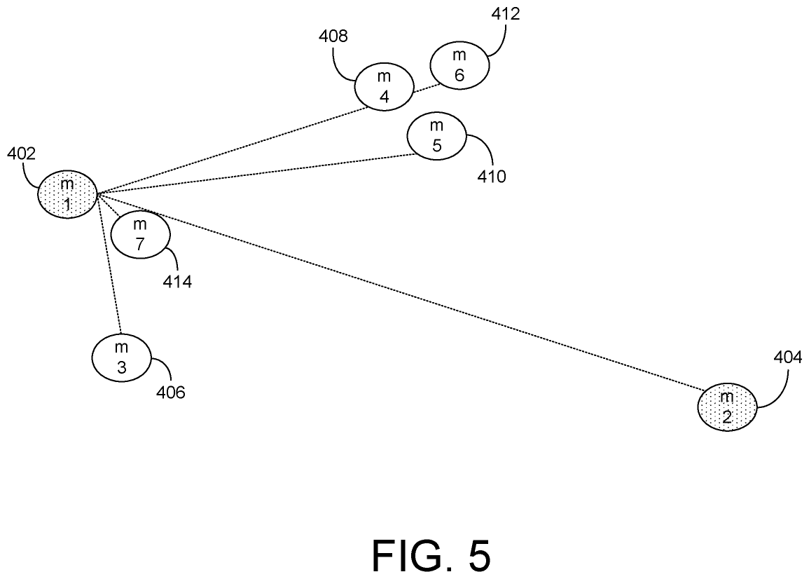

FIG. 5 illustrates a selection of a first dissimilar log record from the log record cluster 415 of FIG. 4. In FIG. 5, and as referenced above, the log record 402 has been designated as the cluster seed. Remaining log records 404, 406, 408, 410, 412, 414 have their relative similarities with the log record 402 illustrated by relative distances from the log record 402, as shown by dashed lines in FIG. 5. As shown, the log record 404 has the greatest distance, and thus the highest dissimilarity (least similarity) with the log record 402.

In FIG. 5, the log record 402 serves as a subset seed for initiating selection of a dissimilar subset of log records from the first cluster 415. In FIG. 5, the log record 402 is thus both the cluster seed and the subset seed. In other examples, however, a log record of the first cluster 415 other than the log record 402 may be selected as the subset seed. For example, a random cluster log record may be selected as the subset seed. In addition, the examples herein assumed that the same similarity algorithm is used for both cluster formation in FIG. 4 and dissimilar subset formation in FIGS. 5-8. However, it is possible to use different similarity algorithms, as well.

FIG. 5 illustrates that when the log record 402 is selected as a subset seed to use in sampling a dissimilar subset from the cluster 415, the log record 404 is determined to be the most dissimilar to the subset seed log record 402. That is, as shown in FIG. 5, the log record 404 has the lowest similarity score with respect to, and is thus farthest from, the subset seed log record 402, as compared to remaining log records 406,408, 410, 412, 414.

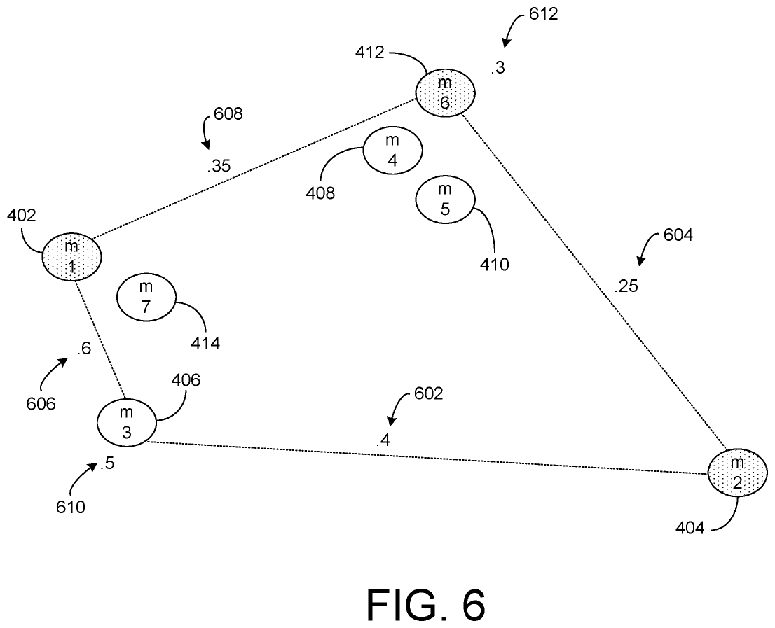

FIG. 6 illustrates a selection process for finding additional dissimilar log records from a log record cluster of FIG. 4. Once a first dissimilar log record (i.e., the log record 404) is determined with respect to the subset seed log record 402, subsequent selections of dissimilar log records may be performed with respect to the dissimilarity criteria that includes some combination or consideration of dissimilarity measures with respect to each or both of the log records 402, 404.

For example, it is not preferable to continually evaluate dissimilarity of subsequently compared log records with respect to the subset seed log record 402. For example, taking such an approach might lead to an undesirable outcome in which many or all of the resulting dissimilar subset are very dissimilar to the individual subset seed log record 402 but very similar to the log record 404 that was the first dissimilar log record selected in the example of FIG. 5.

Instead, once the first dissimilar log record 404 is selected, subsequent selections may also utilize similarity measures determined between the first dissimilar log record 404 and remaining log records of the cluster. For example, in FIG. 6, the first dissimilar log record 404 is illustrated as having a similarity score 602 of 0.4 with respect to the log record 406, and a similarity score 604 of 0.25 with respect to the log record 412. Meanwhile, the subset seed log record 402 is illustrated as having a similarity score 606 of 0.6 with respect to the log record 406, and a similarity score 608 of 0.35 with respect to the log record 412.

In the simplified example of FIG. 6, each remaining log record of the cluster may thus be compared to a desired characterization or aspect of an aggregation of previously selected dissimilar log records. For example, once two dissimilar log records have been identified (e.g., log records 402, 404), a subsequent dissimilar log record (e.g., the log record 412) may be determined with respect to an average dissimilarity calculated using the already selected log records.

For example, in FIG. 6, as already noted, the log record 406 has a similarity score 606 of 6 with respect to the log record 402, and a similarity score 602 of 0.4 with respect to the log record 404. Therefore, as shown, the log record 406 may be said to have an average dissimilarity score 610 of 0.5 (calculated from (0.6+0.4)/2) for purposes of forming a dissimilar subset. Similarly, the log record 412 has a similarity score 604 of 0.25 with respect to the log record 404, and a similarity score 608 of 0.35 with respect to the log record 402. Therefore, as shown, the log record 412 may be said to have an average dissimilarity score 612 of 0.3 (calculated from (0.25+0.35)/2) for purposes of forming a dissimilar subset.

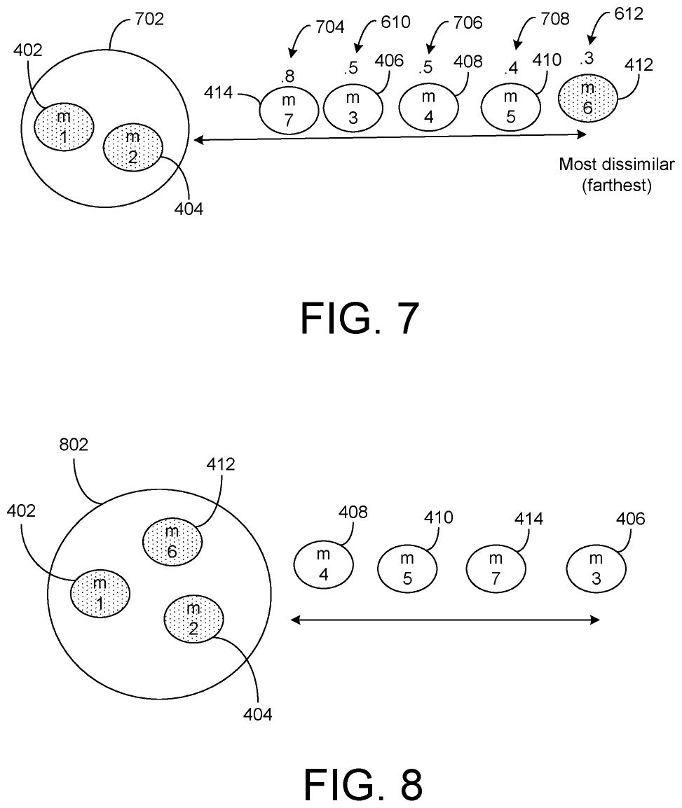

It will be appreciated that FIG. 6, as a simplified example for the sake of explanation, does not explicitly illustrate values of similarity scores between the subset seed log record 402 and each of the remaining log records 408, 410, 414, or between the first dissimilar log record 404 and each of the remaining log records 408, 410, 414. Nonetheless, as may be appreciated from the above discussion, and as referenced below with respect to FIGS. 7 and 8, all such pairwise similarity scores between the subset seed log record 402 and each remaining log record of the cluster, and between the first dissimilar log record 404 and each remaining log record of the cluster may be calculated.

FIG. 7 thus illustrates that a dissimilar subset 702 may be determined from the cluster 415 of FIGS. 4-6, which initially includes the subset seed log record 402 and the first dissimilar log record 404, as may be understood from the example of FIG. 5. FIG. 7 further illustrates that remaining log records may be assigned similarity scores that are calculated as averages with respect to the dissimilar subset 702 being formed.

Specifically, FIG. 7 illustrates that the log record 412 has the average similarity score 612 of 0.3 that is described and illustrated above with respect to FIG. 6, and that the log record 406 has the average similarity score 610 of 0.5 that is also described and illustrated above with respect to FIG. 6. FIG. 7 further illustrates that the log record 414 has an average similarity score 704 of 0.8, the log record 408 has an average similarity score 706 of 0.5, and the log record 410 has an average similarity score 708 of 0.4.

FIG. 8 illustrates that the log record 412 may thus be added to the dissimilar subset 702 to obtain an updated dissimilar subset 802. Then, remaining log records 408, 410, 414, 406 may be assigned average similarity scores with respect to the updated dissimilar subset 802.

If the subset size selector 122 has defined a subset size of three log records, then the dissimilar subset 802 represents a final dissimilar subset. Advantageously, no further processing of the cluster 415 is required once a defined size of a dissimilar subset is reached. If, on the other hand, the subset size selector 122 has defined a subset size larger than three log records, then an updated dissimilar subset may be formed that includes the log record 406 (as having the lowest average similarity score with respect to the dissimilar subset 802).

Although the examples of FIGS. 6-8 utilize an average similarity score with respect to the dissimilar subset being formed, other dissimilarity criteria may be used, as well. For example, the processing described with respect to FIG. 6 may be performed to determine the similarity scores 602, 604 with respect to the most dissimilar log record 404, as already described. Instead of then finding average similarity scores 610, 612, processing may proceed to identify a maximum similarity score for each log record being analyzed.

For example, the log record 406 has similarity score 606 of 0.6 with respect to the log record 402, but has similarity score 602 of 0.4 with respect to the log record 404. Consequently, the maximum similarity score would be the similarity score 606 of 0.6. Meanwhile, the log record 412 has similarity score 608 of 0.35 with respect to the log record 402, but has similarity score 604 of 0.25 with respect to the log record 404. Consequently, the maximum similarity score would be the similarity score 608 of 0.35.

In this example, a dissimilar log record may then be selected as the log record having the minimum of the selected maximum similarity scores. That is, as just described, the maximum similarity scores are determined to be 0.6 and 0.35, of which 0.35 is the minimum. As a result, the log record 412 would then be selected for addition to the dissimilar subset 702 of FIG. 7, mirroring the outcome of the previously described analysis based on average similarity scores.

In the immediately preceding example, the log record 406 is effectively penalized for being more similar to the log record 402 than the log record 412. The log record 412 is thus selected, which accomplishes the goal of optimizing or maximizing a total dissimilarity of all log records of the dissimilar subset 702 of FIG. 7. As also described above, similar processing may continue until a desired size of a resulting dissimilar subset is reached.

FIG. 9 is a block diagram illustrating example techniques for identifying an optimized number of dissimilar log records to select from the log record cluster of FIG. 4, using the techniques of FIGS. 5-8. In other words, FIG. 9 illustrates example operations of the subset size selector 122 of FIG. 1.

In FIG. 9, as described with respect to FIG. 1, the log record repository 109 stores all available log records that may be used to train the reference model 129. The sampled training data 124 represents aggregated dissimilar subsets selected by the dissimilar subset selector 120.

By comparing an accuracy (902) of the sampled model 128 with an accuracy of the reference model 129, the subset size selector 122 may determine an optimal size “k” of dissimilar log records to be included in each dissimilar subset. Specifically, for example, the subset size selector 122 may iterate (904) over multiple dissimilar subset sizes until a size “k” is reached that provides a desired level of accuracy with respect to the accuracy of the reference model 129.

For example, an initial size k of 20% may be used in a first iteration of FIG. 9, so that the sampled training data is 20% of the size of the log record repository 109. Subsequent accuracy comparison (902) may show that, when k=205, the sampled model 128 is 80% as accurate as the reference model 129. In a second iteration (904), the sampled training data may be set to 25% of the size of the log record repository 109. Subsequent accuracy comparison (902) may show that the sampled model 128 is then 90% as accurate as the reference model 129. In a third iteration (904), the sampled training data may be 30% of the size of the log record repository 109. Subsequent accuracy comparison (902) may show that the sampled model 128 is 99% as accurate as the reference model 129. Iterations (904) may then complete, as the sampled model 128 provides 99% of the accuracy of the reference model 129, while requiring only 30% of the data required to train the reference model 129.

Thus, FIG. 9 illustrates that design choices may be made to balance a desired level of accuracy with a corresponding size of sampled data. In other words, a designer may choose to have a lower higher level of accuracy for the benefit (cost) of requiring a smaller quantity of sampled data, or a higher level of accuracy for the cost of requiring a larger quantity of sampled data.

FIG. 10 is a flowchart illustrating operations corresponding to the techniques of FIGS. 3-9. FIG. 10 illustrates both a first run model creation (1002) and initial log record sampling, as well as subsequent, periodic log record sampling (1004) for incremental cluster building.

That is, during an initial log record sampling when the sampled model 128 is first being constructed, a relevant set of log records may be read, and dates included in the log records may be masked (1006). That is, as described, calendar dates and/or timestamps may be unhelpful at best with respect to training the sampled model 128, and at worst may consume resources unnecessarily and/or reduce an accuracy of the sampled model. Consequently, the cluster generator 118 or other suitable component may filter or mask such date/time information prior to further processing.

Log records may then be clustered to form clusters in which all included log records have at least an 80% similarity score with respect to a cluster seed of a corresponding cluster (1008). As described above, an initial cluster seed log record may be selected randomly, and then a compared log record may be compared to the cluster seed and relative to the 80% similarity score threshold. Compared log records at or above the threshold may be added to the cluster, while compared log records below the threshold may be used as a cluster seed(s) of new clusters.

For each cluster, a most dissimilar (least similar) log record with respect to the cluster seed of that cluster may be selected (1010). The cluster seed log records and its most-dissimilar log record within the cluster thus form an initial dissimilar subset for that cluster (1012).

If the subset size is less than a previously selected size (e.g., a size selected using the techniques of FIG. 9), then another dissimilar log record may be identified as being most dissimilar (least similar) with respect to an average similarity score of existing log records already contained within the dissimilar subset (1016), as described above with respect to FIGS. 6-8, so that the dissimilar subset may be increased (1012) until the size of the dissimilar subset is at or above the selected size (1014).

After an initial instance of the sampled model has been constructed (1002), e.g., after passage of some pre-determined quantity of time, incremental cluster building may be implemented (1004). For example, log records received since a time of creation of the (most recent) sampled model 128 may be retrieved (1018). If a new log record is included (1020), then the new log record(s) may be added to the previously clustered log records (1022).

The previously described operations (1008, 1010, 1012, 1014, 1016) may then proceed by modifying each cluster only if needed, and, similarly, modifying each dissimilar subset only if needed. For example, a new log record may be added only to the cluster for which the new log record is an 80% similarity score match with the cluster seed log record of that cluster. If no such similarity score match is found, the new log record may be used to define a new cluster.

If the new log record is added to an existing cluster, then that cluster is analyzed to determine whether the new log record is more dissimilar to an average similarity of existing log records than any particular log record already included in the dissimilar subset. If so, the new log record may replace that particular log record.

Put another way, the cluster generator 118 and the dissimilar subset selector 120 may be configured to repeat a minimum of operational steps required to determine whether the new log record would have been included in a cluster, or in the cluster's sampled dissimilar subset, if the new log record had been present when the cluster/dissimilar subset was originally formed. In some implementations, the cluster generator 118 and the dissimilar subset selector 120 may store previously calculated similarity scores and results of other calculations, in order to process new log records more quickly and efficiently.

Described techniques determine an appropriate data sampling and selection that selects a minimum amount of sampled data to achieve a desired level of accuracy. The sampled data includes the most informative records for training a machine learning model, e.g., using a deep learning algorithm known as Auto-encoder for Anomaly detection and implemented using the TensorFlow library. Resulting sampled log records are dissimilar and diverse and may have an optimal sampled size for a desired level of accuracy, while retaining almost a full context from historical or past log records that would be useful for training relevant ML algorithm(s).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, a mainframe computer(s), or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive a plurality of log records characterizing operations occurring within a technology landscape;
cluster the plurality of log records into at least a first cluster of log records and a second cluster of log records, using at least one similarity algorithm;
identify a first dissimilar subset of log records within the first cluster of log records, using the at least one similarity algorithm;
identify a second dissimilar subset of log records within the second cluster of log records, using the at least one similarity algorithm; and
train at least one machine learning model to process new log records characterizing the operations occurring within the technology landscape, using the first dissimilar subset and the second dissimilar subset.

2. The computer program product of claim 1, wherein the instructions, when executed, are further configured to cause the at least one computing device to:
select a first cluster seed log record from the plurality of log records;
determine a similarity score between the first cluster seed log record and a first compared log record, using the at least one similarity algorithm; and
add the first compared log record to the first cluster when the similarity score is at or above a similarity score threshold.

3. The computer program product of claim 1, wherein the instructions, when executed, are further configured to cause the at least one computing device to:
select a first cluster seed log record from the plurality of log records;
determine a first similarity score between the first cluster seed log record and a first compared log record, using the at least one similarity algorithm; and
designate the first compared log record as a second cluster seed log record for the second cluster when the first similarity score is below a similarity score threshold.

4. The computer program product of claim 3, wherein the instructions, when executed, are further configured to cause the at least one computing device to:
add a second compared log record to the second cluster when a second similarity score between the second compared log record and the second cluster seed log record is at or above the similarity score threshold.

5. The computer program product of claim 1, wherein the instructions, when executed, are further configured to cause the at least one computing device to:
identify first similarity scores between a cluster seed log record of the first cluster and each remaining log record of the first cluster;
identify a lowest similarity score of the first similarity scores; and
include a first dissimilar log record having the lowest similarity score in the first dissimilar subset.

6. The computer program product of claim 5, wherein the instructions, when executed, are further configured to cause the at least one computing device to:
identify second similarity scores between the first dissimilar log record and each remaining log record of the first cluster;
calculate average similarity scores for remaining log record with respect to the cluster seed log record and the first dissimilar log record, using the first similarity scores and the second similarity scores; and
select a second dissimilar log record to include in the first dissimilar subset, the second dissimilar log record having a lowest average similarity score of the average similarity scores.

7. The computer program product of claim 1, wherein the instructions, when executed, are further configured to cause the at least one computing device to:
train at least one reference machine learning model using the plurality of log records; and
designate a size of each of the first dissimilar subset and the second dissimilar subset based on a comparison of accuracy of the at least one machine learning model and the at least one reference machine learning model.

8. The computer program product of claim 1, wherein the instructions, when executed, are further configured to cause the at least one computing device to:
process the new log records using the at least one machine learning model to detect at least one anomaly in the technology landscape.

9. The computer program product of claim 1, wherein the instructions, when executed, are further configured to cause the at least one computing device to:
retrieve, following the training, at least one additional log record; and
replace at least one log record in the first cluster of log records with the at least one additional record.

10. The computer program product of claim 1, wherein the instructions, when executed, are further configured to cause the at least one computing device to:
retrieve, following the training, at least one additional log record; and
replace at least one log record in the first dissimilar subset with the at least one additional record.

11. A computer-implemented method, the method comprising:
receiving a plurality of log records characterizing operations occurring within a technology landscape;
clustering the plurality of log records into at least a first cluster of log records and a second cluster of log records, using at least one similarity algorithm;
identifying a first dissimilar subset of log records within the first cluster of log records, using the at least one similarity algorithm;
identifying a second dissimilar subset of log records within the second cluster of log records, using the at least one similarity algorithm; and
training at least one machine learning model to process new log records characterizing the operations occurring within the technology landscape, using the first dissimilar subset and the second dissimilar subset.

12. The method of claim 11, further comprising:
selecting a first cluster seed log record from the plurality of log records;
determining a similarity score between the first cluster seed log record and a first compared log record, using the at least one similarity algorithm; and
adding the first compared log record to the first cluster when the similarity score is at or above a similarity score threshold.

13. The method of claim 11, further comprising:
selecting a first cluster seed log record from the plurality of log records;
determining a first similarity score between the first cluster seed log record and a first compared log record, using the at least one similarity algorithm; and
designating the first compared log record as a second cluster seed log record for the second cluster when the first similarity score is below a similarity score threshold.

14. The method of claim 13, further comprising:
adding a second compared log record to the second cluster when a second similarity score between the second compared log record and the second cluster seed log record is at or above the similarity score threshold.

15. The method of claim 11, further comprising:
identifying first similarity scores between a cluster seed log record of the first cluster and each remaining log record of the first cluster;
identifying a lowest similarity score of the first similarity scores; and
including a first dissimilar log record having the lowest similarity score in the first dissimilar subset.

16. The method of claim 15, further comprising:
identifying second similarity scores between the first dissimilar log record and each remaining log record of the first cluster;
calculating average similarity scores for remaining log record with respect to the cluster seed log record and the first dissimilar log record, using the first similarity scores and the second similarity scores; and
selecting a second dissimilar log record to include in the first dissimilar subset, the second dissimilar log record having a lowest average similarity score of the average similarity scores.

17. The method of claim 11, further comprising:
training at least one reference machine learning model using the plurality of log records; and
designating a size of each of the first dissimilar subset and the second dissimilar subset based on a comparison of accuracy of the at least one machine learning model and the at least one reference machine learning model.

18. A system comprising:
at least one memory including instructions; and
at least one processor that is operably coupled to the at least one memory and that is arranged and configured to execute instructions that, when executed, cause the at least one processor to:
receive a plurality of log records characterizing operations occurring within a technology landscape;
cluster the plurality of log records into at least a first cluster of log records and a second cluster of log records, using at least one similarity algorithm;
identify a first dissimilar subset of log records within the first cluster of log records, using the at least one similarity algorithm;
identify a second dissimilar subset of log records within the second cluster of log records, using the at least one similarity algorithm; and
train at least one machine learning model to process new log records characterizing the operations occurring within the technology landscape, using the first dissimilar subset and the second dissimilar subset.

19. The system of claim 18, wherein the instructions, when executed, are further configured to cause the at least one processor to:
select a first cluster seed log record from the plurality of log records;
determine a similarity score between the first cluster seed log record and a first compared log record, using the at least one similarity algorithm; and
add the first compared log record to the first cluster when the similarity score is at or above a similarity score threshold.

20. The system of claim 18, wherein the instructions, when executed, are further configured to cause the at least one processor to:
identify first similarity scores between a cluster seed log record of the first cluster and each remaining log record of the first cluster; and
identify a lowest similarity score of the first similarity scores; and
include a first dissimilar log record having the lowest similarity score in the first dissimilar subset.
